(19) United States
(12) Patent Application Publication
(10) Pub. No.: US 2019/0050734 A1
(43) Pub. Date: Feb. 14, 2019

(54) COMPRESSION METHOD OF DEEP NEURAL NETWORKS

(71) Applicant: BEIJING DEEPHI INTELLIGENCE TECHNOLOGY CO., LTD., Beijing (CN)

(72) Inventors: Xin LI, Beijing (CN); Tong MENG, Beijing (CN); Song HAN, Beijing (CN)

(21) Appl. No.: 15/693,488

(22) Filed: Sep. 1, 2017

(30) Foreign Application Priority Data
Aug. 8, 2017 (CN) 201710671193.7

(51) Int. Cl. G06N 3/08; G06N 3/04

(52) U.S. Cl. CPC G06N 3/082; G06N 3/04

(57) ABSTRACT

The present disclosure proposes an improved compression method for neural networks (e.g. LSTM), which may effectively shorten the training period of a neural network by combining pruning operation into the training process, so as to reduce the number of iteration in the training process.

### CROSS REFERENCE TO RELATED APPLICATIONS

This application claims priority to Chinese Patent Application Number 201710671193.7 filed on Aug. 8, 2017, the entire contents of which are incorporated herein by reference.

### TECHNICAL FIELD

The present disclosure relates to a compression method and apparatus for deep neural networks.

### BACKGROUND ART

### Artificial Neural Networks

Artificial Neural Networks (ANNs), also called NNs, are a distributed parallel information processing models which imitate behavioral characteristics of animal neural networks. In recent years, studies of ANNs have achieved rapid developments, and ANNs have been widely applied in various fields, such as image recognition, speech recognition, natural language processing, gene expression, contents pushing, etc.

In neural networks, there exists a large number of nodes (also called “neurons”) which are connected to each other. Each neuron calculates the weighted input values from other adjacent neurons via certain output function (also called “Activation Function”), and the information transmission intensity between neurons is measured by the so-called “weights”. Such weights might be adjusted by self-learning of certain algorithms.

Early neural networks have only two layers: the input layer and the output layer. Thus, these neural networks cannot process complex logic, limiting their practical use. Deep Neural Networks (DNNs) have revolutionarily addressed such defect by adding a hidden intermediate layer between the input layer and the output layer, improving network performance in handling complex problems. FIG. 1 shows a schematic diagram of a deep neural network.

In order to adapt to different application scenarios, different neutral network structures have been derived from conventional deep neural network. For example, Recurrent Neural Network (RNN) is a commonly used type of deep neural network. Different from conventional feed-forward neural networks, RNNs have introduced oriented loop and are capable of processing forward-backward correlations between inputs. The neuron may acquire information from neurons in the previous layer, as well as information from the hidden layer where said neuron locates. Therefore, RNNs are particularly suitable for sequence related problems. For example, in speech recognition, there are strong forward-backward correlations between signals. In other works, one word is closely related to its preceding word in a series of voice signals. Thus, RNNs are widely applied in speech recognition.

The application of deep neural networks generally includes two phases: the training phase and the inference phase.

The purpose of training a neural network is to improve the learning ability of the network. The neural network calculates the prediction result of an input feature via forward propagation, and then compares the prediction result with a standard answer. The difference between the prediction result and the standard answer will be sent back the neural network via backward propagation. The weights of the network will be updated using the said difference.

Once the training process is completed, the trained neural network may be applied for actual scenarios, i.e., the inference phase may start. In this phase, the network will calculate a reasonable prediction result of an input feature via forward propagation.

### Compression of Artificial Neural Networks

In recent years, the scale of neural networks is exploding due to rapid developments. Some of the advanced neural network models might have hundreds of layers and billions of connections, and the implementation thereof is both calculation-centric and memory-centric. Since neural networks are becoming larger, it is critical to compress neural network models into smaller scale.

In deep neural networks, connection relations between neurons can be expressed mathematically as a series of matrices. Although a well-trained neural network is accurate in prediction, its matrices are dense matrices. In other words, the matrices are filled with non-zero elements, consuming extensive storage resources and computation resources, which reduces computational speed and increases costs. Thus, it is difficult to deploy deep neural networks in mobile terminals, significantly restricting practical use and development of neural networks. Therefore, dense neural networks are usually compressed into sparse neural networks before use.

FIG. 2 is a schematic diagram showing the training and compression process of a neural network.

As shown in FIG. 2, it firstly trains the neural network to obtain a trained neural network with a desired accuracy. Then, it prunes and fine-tunes the trained neural network, so as to obtain a sparse neural network.

In recent years, studies have shown that in the matrices of a trained neural network model, elements with larger weights represent important connections, while other elements with smaller weights have relatively small impact and can be removed (e.g., set to zero). The operation of setting elements with smaller weights to zero is called “pruning”. The accuracy of the neural network after pruning may decrease. However, by fine-tuning (also refer to as “fine-tuning”) the pruned neural network, the remaining weights in the matrices may be adjusted, minimizing the accuracy loss.

FIG. 3 shows synapses and neurons before and after pruning according to the method proposed in FIG. 2, which results in a sparse neural network.

By compressing a dense neural network into a sparse neural network, the computation amount and storage amount can be effectively reduced, achieving acceleration of running an ANN while maintaining its accuracy. Compression of neural network models are especially important for specialized sparse neural network accelerator.

### Speech Recognition

Speech recognition is to sequentially map analogue signals of a language to a specific set of words. In recent years, deep neural networks have been widely applied in speech recognition field.

FIG. 4 shows an example of a speech recognition engine using deep neural networks.

In the model shown in FIG. 4, it calculates acoustic output probability using a deep learning model. In other words, it conducts similarity prediction between a series of input speech signals and various possible candidates. Moreover, FPGA, for example, may be used to accelerate the running of the DNN in FIG. 4.

FIGS. 5a and 5b show a deep learning model applied in the speech recognition engine of FIG. 4.

The deep learning model shown in FIG. 5a includes CNN (Convolutional Neural Network) module, LSTM (Long Short-Term Memory) module, DNN (Deep Neural Network) module, Softmax module, etc. The deep learning model shown in FIG. 5b includes multi-layers of LSTM.

### LSTM

In order to solve long-term information storage problem, Hochreiter & Schmidhuber has proposed the Long Short-Term Memory (LSTM) model in 1997.

LSTM neural network is one type of RNN. The main difference between RNNs and DNNs lies in that RNNs are time-dependent. More specifically, the input at time T depends on the output at time T−1. That is, calculation of the current frame depends on the calculated result of the previous frame. Moreover, LSTM neural network changes simple repetitive neural network modules in normal RNN into complex interconnecting relations. LSTM neural network has achieved very good effect in speech recognition.

For more details of LSTM, prior art references can be made mainly to the following two published papers: Sak H, Senior A W, Beaufays F. Long short-term memory recurrent neural network architectures for large scale acoustic modeling[C]//INTERSPEECH. 2014: 338-342; Sak H, Senior A, Beaufays F. Long short-term memory based recurrent neural network architectures for large vocabulary speech recognition[J]. arXiv preprint arXiv: 1402.1128, 2014.

FIG. 6 shows an LSTM neural network model applied in speech recognition.

In the LSTM architecture of FIG. 6:
Symbol i represents the input gate i which controls the flow of input activations into the memory cell;
Symbol o represents the output gate o which controls the output flow of cell activations into the rest of the network;
Symbol f represents the forget gate which scales the internal state of the cell before adding it as input to the cell, therefore adaptively forgetting or resetting the cell's memory;
Symbol g represents the characteristic input of the cell;
The bold lines represent the output of the previous frame,
Each gate has a weight matrix, and the computation amount for the input at time T and the output at time T−1 at the gates is relatively intensive;
The dashed lines represent peephole connections, and the operations correspond to the peephole connections and the three cross-product signs are element-wise operations, which require relatively little computation amount.

FIG. 7 shows an improved LSTM network model applied in speech recognition.

As shown in FIG. 7, in order to reduce the computation amount of the LSTM layer, an additional projection layer is introduced to reduce the dimension of the model.

The equations corresponding to the LSTM network model shown in FIG. 7 is as follows (assuming that the LSTM network accepts an input sequence x=(x₁, . . . , x_{T}), and computes an output sequence y=(y₁, . . . , y_{T}) by using the following equations iteratively from t=1 to T):

iₜ=σ(Wᵢₓxₜ+Wᵢᵣyₜ₋₁+W_{ic}cₜ₋₁+bᵢ)

fₜ=σ(W_{fx}xₜ+W_{fr}yₜ₋₁+W_{fc}cₜ₋₁+b_{f})

cₜ=fₜ⊙cₜ₋₁+iₜ⊙g(W_{cx}xₜ+W_{cr}yₜ₋₁+b_{c})

oₜ=σ(Wₒₓxₜ+Wₒᵣyₜ₋₁+W_{oc}cₜ₋₁+bₒ)

mₜ=oₜ⊙h(cₜ)

yₜ=W_{ym}mₜ

Here, σ( ) represents the activation function sigmoid. W terms denote weight matrices, wherein Wᵢₓ is the matrix of weights from the input gate to the input, and W_{ic}, W_{fc}, W_{oc} are diagonal weight matrices for peephole connections which correspond to the three dashed lines in FIG. 7. Operations relating to the cell are multiplications of vector and diagonal matrix.

The b terms denote bias vectors (bᵢ is the gate bias vector). The symbols i, f, o, c are respectively the input gate, forget gate, output gate and cell activation vectors, and all of which are the same size as the cell output activation vectors m. ⊙ is the element-wise product of the vectors, g and h are the cell input and cell output activation functions, generally tan h.

When designing and training deep neural networks, networks with larger scale can express strong non-linear relation between input and output features. However, when learning a desired mode, networks with larger scale are more likely to be influenced by noises in training sets, leading to differences between the mode learnt by the network and the desired mode.

Therefore, it is desired to propose a compression method for neural networks (e.g. LSTM), which can compress a dense neural network into a sparse neural network while maintaining its accuracy. More specifically, it is desired to propose a compression method for neural networks (e.g. LSTM), which can shorten the training or fine-tuning period of the neural network while maintaining its accuracy.

### SUMMARY

The present disclosure proposes an improved compression method for neural networks (e.g. LSTM), which may effectively shorten the training period of a neural network by combining pruning operation into the training process, so as to reduce the number of iteration in the training process. The compression method of the present application may also be applied to the fine-tuning process of a trained neural network, so as to compress the neural network while maintaining its accuracy.

According to one aspect of the disclosure, it proposes a method for compressing an original dense neural network, wherein said neural network is characterized by a plurality of matrices, said method comprising: an initial training step, for training said raw dense neural network, so that it converges to an intermediate dense neural network; a compression strategy determining step, for determining a compression strategy of a compression cycle, said compression strategy at least comprising: the target compression ratio of each pruning operation within said compression cycle, the total number of pruning operation to be conducted, and a target compression ratio of said compression cycle; and a pruning and fine-tuning step, for pruning and fine-tuning said intermediate dense neural network based on said compression strategy, until said intermediate dense neural network is compressed into a sparse neural network having said target compression ratio of said compression cycle.

According to another aspect of the disclosure, it proposes an apparatus for compressing a raw dense neural network, wherein said neural network is characterized by a plurality of matrices, said method comprising: an initial training module, for training said raw dense neural network, so that it converges to an intermediate dense neural network; a compression strategy determining module, for determining a compression strategy of a compression cycle, said compression strategy at least comprising: target compression ratio of each pruning operation within said compression cycle, the total number of pruning operations to be conducted, and a target compression ratio of said compression cycle; and a pruning and fine-tuning module, for pruning and fine-tuning said intermediate dense neural network based on said compression strategy, until said intermediate dense neural network is compressed into a sparse neural network having said target compression ratio of said compression cycle.

It is to be understood that both the foregoing general description and the following detailed description are exemplary and explanatory only and are not limitations to the invention.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 shows a schematic diagram of a deep neural network;

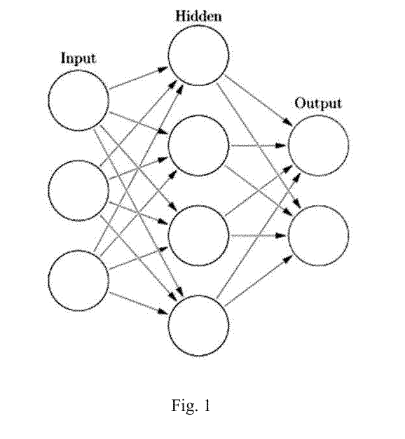

FIG. 2 is a schematic diagram showing the training and compression process of a neural network;

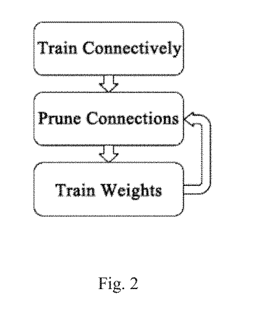

FIG. 3 shows synapses and neurons before and after pruning according to the method proposed in FIG. 2;

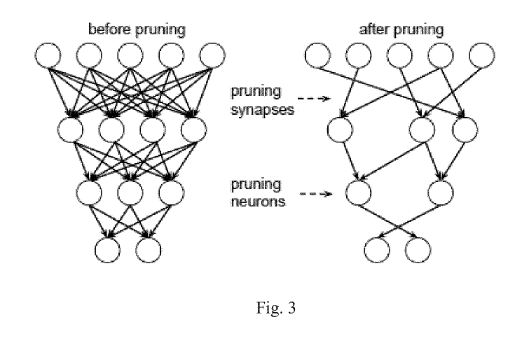

FIG. 4 shows an example of a speech recognition engine using deep neural networks;

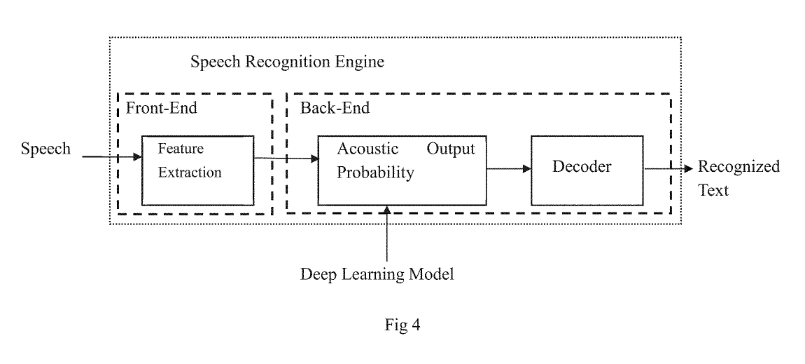

FIGS. 5a and 5b show a deep learning model applied in the speech recognition engine of FIG. 4;

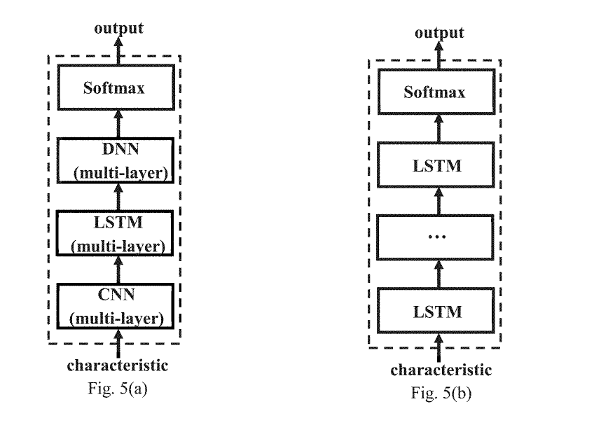

FIG. 6 shows an LSTM neural network model applied in speech recognition;

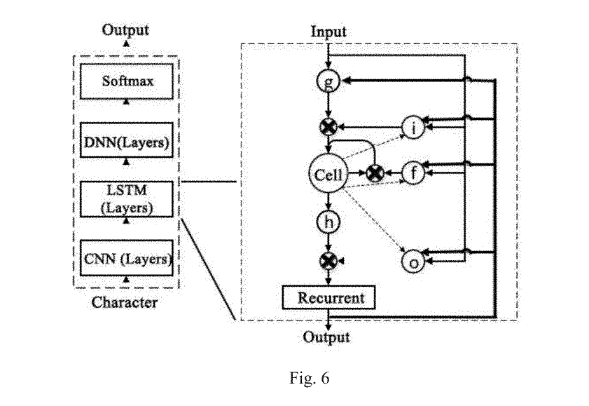

FIG. 7 shows an improved LSTM network model applied in speech recognition;

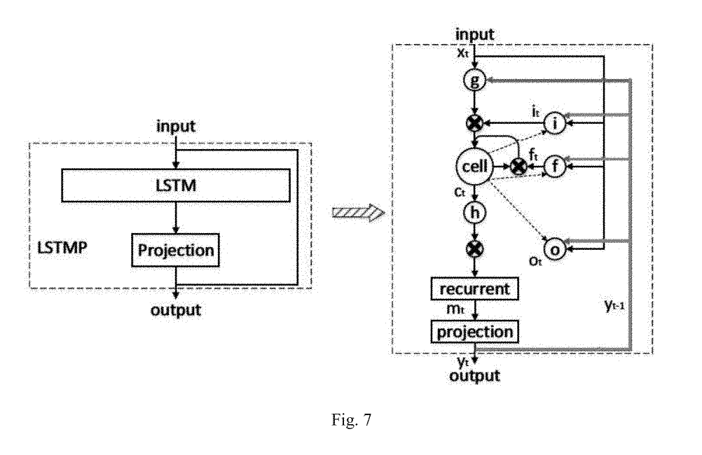

FIG. 8 shows a compression method for LSTM neural networks according to a first embodiment of the present disclosure;

FIG. 9 shows the steps in sensitivity analysis according to the embodiment shown in FIG. 8;

FIG. 10 shows the corresponding curves obtained by the sensitivity tests of FIG. 9;

FIG. 11 shows the steps in density determination and pruning according to the embodiment shown in FIG. 8;

FIG. 12 shows the sub-steps in “Compression-Density Adjustment” iteration of FIG. 11;

FIG. 13a shows the steps in fine-tuning according to the embodiment shown in FIG. 8,

FIG. 13b is a schematic diagram showing the training/fine-tuning process of a neural network using the Gradient Descent Algorithm;

FIG. 14 shows the process of fine-tuning a neural network using a mask matrix;

FIG. 15 shows the steps in one compression cycle of a compression method for LSTM neural networks according to a second embodiment of the present disclosure;

FIG. 16 shows the density variation curve of the neural network in Example 2.1 according to the second embodiment of the present disclosure;

FIG. 17 shows the variation of weight distribution of the neural network in Example 2.1 according to the second embodiment of the present disclosure;

FIG. 18 shows the variation of weights of a neural network being compressed using a mask;

FIG. 19 shows the density variation curve of the neural network in Example 2.2 according to the second embodiment of the present disclosure;

FIG. 20 shows the variation of weights of the neural network in Example 2.2 according to the second embodiment of the present disclosure;

FIG. 21 shows the variation of WER of the neural network in Example 2.2 according to the second embodiment of the present disclosure;

FIG. 22 shows the density variation curve of a neural network trained and compressed according to the second embodiment of the present disclosure, and the density variation curve of a neural network trained and compressed without applying the second embodiment of the present disclosure.

Specific embodiments in this disclosure have been shown by way of examples in the foregoing drawings and are hereinafter described in detail. The figures and written description are not intended to limit the scope of the inventive concepts in any manner. Rather, they are provided to illustrate the inventive concepts to a person skilled in the art by reference to particular embodiments.

### EMBODIMENTS OF THE INVENTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with some aspects related to the invention as recited in the appended claims.

### Embodiment 1

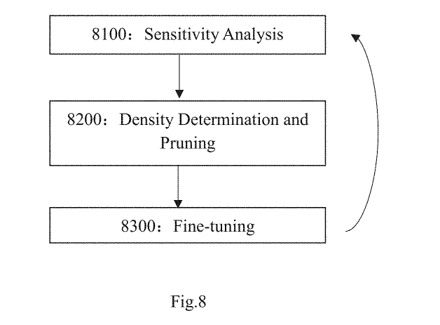

FIG. 8 shows a compression method for LSTM neural networks according to a first embodiment of the present disclosure;

According to the embodiment shown in FIG. 8, a LSTM neural network is compressed via a plurality of iterations, wherein each iteration comprises the following three steps: sensitivity analysis, pruning and fine-tuning. Now, each step will be explained in detail.

Step 8100: Sensitivity Analysis

In this step, sensitivity analysis is conducted for all the matrices in a LSTM network, so as to determine the initial densities (or, the initial compression ratios) for each matrix in the neural network.

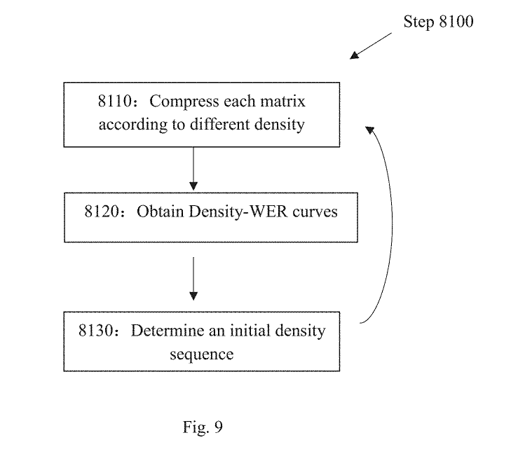

FIG. 9 shows the specific steps in sensitivity analysis according to this embodiment.

As can be seen from FIG. 9, in step 8110, it compresses each matrix in LSTM network according to different densities (for example, the selected densities are 0.1, 0.2 . . . 0.9, and the related compression method is explained in detail in step 8200).

Next, in step 8120, it measures the word error ratio (WER) of the neural network compressed under different densities. More specifically, when recognizing a sequence of words, there might be words that are mistakenly inserted, deleted or substituted. For example, for a text of N words, if I words were inserted, D words were deleted and S words were substituted, then the corresponding WER will be:

WER=(I+D+S)/N.

WER is usually measured in percentage. In general, the WER of a neural network after compression will increase, which means that the accuracy of the network after compression will decrease.

In step 8120, for each matrix, it draws a Density-WER curve based on the measured WERs as a function of different densities, wherein x-axis represents the density and y-axis represents the WER of the network after compression.

In step 8130, for each matrix, it locates the point in the Density-WER curve where WER changes most abruptly, and choose the density that corresponds to said point as the initial density.

In this embodiment, we select the density which corresponds to the inflection point in the Density-WER curve as the initial density of the matrix. More specifically, in one iteration, the inflection point is determined as follows:

The WER of the neural network before compression in the present iteration is known as WERᵢₙᵢₜᵢₐₗ;

The WER of the network after compression according to different densities is: WER_{0.1}, WER_{0.2} . . . WER_{0.9}, respectively;

Calculate ΔWER, i.e., compare WER_{0.1} with WERᵢₙᵢₜᵢₐₗ, WER_{0.2} with WERᵢₙᵢₜᵢₐₗ . . . , WER_{0.9} with WERᵢₙᵢₜᵢₐₗ respectively.

Based on the calculated ΔWERs, the inflection point refers to the point having the smallest density among all the points and also having a ΔWER below a certain threshold. However, it should be understood that the point where WER changes most abruptly can be selected according to other criteria, and all such variants shall fall into the scope of the present disclosure.

Based on the method described above, for a LSTM network with 3 layers where each layer comprises 9 dense matrices (Wᵢₓ, W_{fx}, W_{cx}, Wₒₓ, Wᵢᵣ, W_{fr}, W_{cr}, Wₒᵣ, and Wᵣₘ) to be compressed, the initial density sequence is determined as follows.

First of all, for each matrix, it conducts 9 compression tests with different densities ranging from 0.1 to 0.9 with a step of 0.1. Then, for each matrix, it measures the WER of the whole network after each compression test, and draws the corresponding Density-WER curve. Therefore, for a total number of 27 matrices, we obtain 27 curves.

Next, for each matrix, it locates the inflection point in the corresponding Density-WER curve. Here, we assume that the inflection point is the point having the smallest density among all the points and also having a ΔWER below 1%.

For example, in the present iteration, assuming that the WER of the initial neural network before compression is 24%, then the point having the smallest density among all the points and also having a WER below 25% is chosen as the inflection point, and the corresponding density of this inflection point is chosen as the initial density of the corresponding matrix.

In this way, we will obtain an initial density sequence of 27 values, each corresponding to the initial density of the corresponding matrix. Thus, this sequence can be used as guidance for further compression.

An example of the initial density sequence is as follows, wherein the order of the matrices is W_{cx}, Wᵢₓ, W_{fx}, Wₒₓ, W_{cr}, Wᵢᵣ, W_{fr}, Wₒᵣ and Wᵣₘ:

densityList=[0.2, 0.1, 0.1, 0.1, 0.3, 0.3, 0.1, 0.1, 0.3, 0.5, 0.1, 0.1, 0.1, 0.2, 0.1, 0.1, 0.1, 0.3, 0.4, 0.3, 0.1, 0.2, 0.3, 0.3, 0.1, 0.2, 0.5]

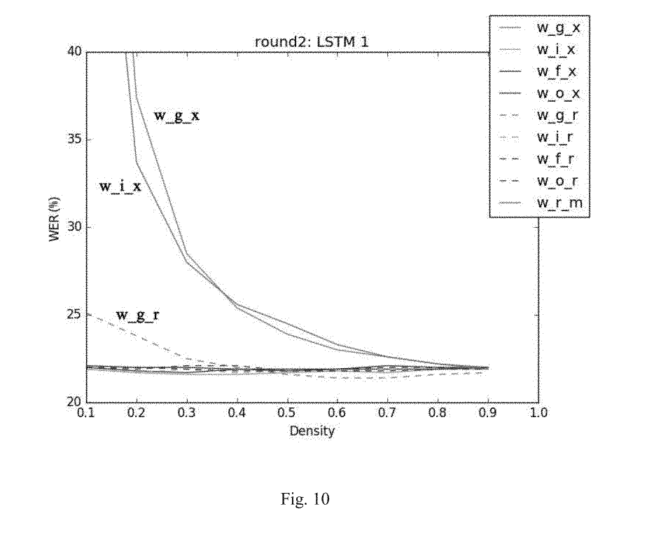

FIG. 10 shows the corresponding Density-WER curves of the 9 matrices in one layer of the LSTM neural network. As can be seen from FIG. 10, the sensitivity of each matrix to be compressed differs dramatically. For example, w_g_x, w_r_m, w_g_r are more sensitive to compression as there are points with max (ΔWER)>1% in their Density-WER curves.

Step 8200: Density Determination and Pruning

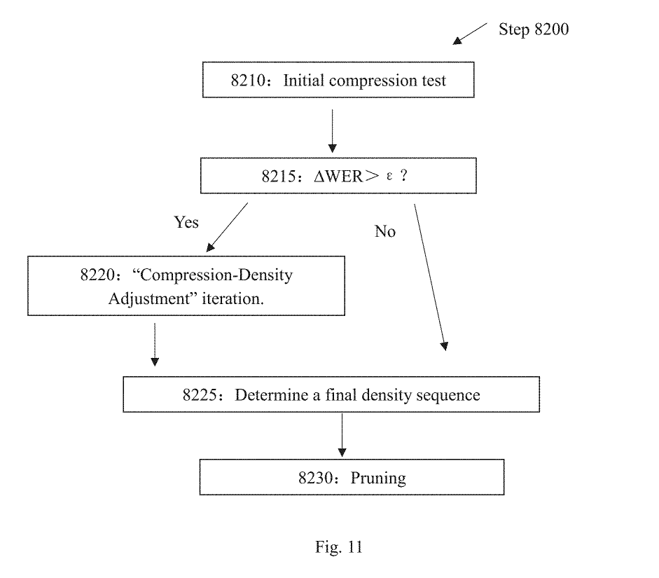

FIG. 11 shows the specific steps in density determination and pruning. As can be seen from FIG. 11, step 8200 comprises several sub-steps.

First of all, in step 8210, it compresses each matrix based on the initial density sequence determined in step 8130.

Then, in step 8215, it measures the WER of the neural network obtained in step 8210. If ΔWER of neural networks before and after compression is above a certain threshold ε, for example, 4%, then it goes to the next step 8220. If ΔWER of the neural networks before and after compression does not exceed said threshold ε, then it goes to step 8225 directly, and the initial density sequence is set as the final density sequence.

In step 8220, it adjusts the initial density sequence via “Compression-Density Adjustment” iteration.

In step 8225, it obtains the final density sequence.

Lastly, in step 8230, it prunes the LSTM neural network based on the final density sequence.

Now, each sub-step in FIG. 11 will be explained in more detail.

In Step 8210, it conducts an initial compression test based on the initial density sequence.

Based on previous studies, the weights with larger absolute values in a matrix correspond to stronger connections between the neurons. Thus, in this embodiment, compression is made according to the absolute values of elements in a matrix.

More specifically, in each matrix, all the elements are ranked from small to large according to their absolute values. Then, each matrix is compressed according to the initial density determined in Step 8100, and only a corresponding ratio of elements with larger absolute values are remained, while other elements with smaller values are set to zero. For example, if the initial density of a matrix is 0.4, then only 40% of the elements in said matrix with larger absolute values are remained, while the other 60% of the elements with smaller absolute values are set to zero.

In Step 8215, it determines whether ΔWER of the networks before and after compression is above a certain threshold ε, for example, 4%.

In Step 8220, it conducts the “Compression-Density Adjustment” iteration if ΔWER of the network before and after compression is above said threshold ε, for example, 4%.

In Step 8225, it obtains the final density sequence through density adjustment performed in step 8220.

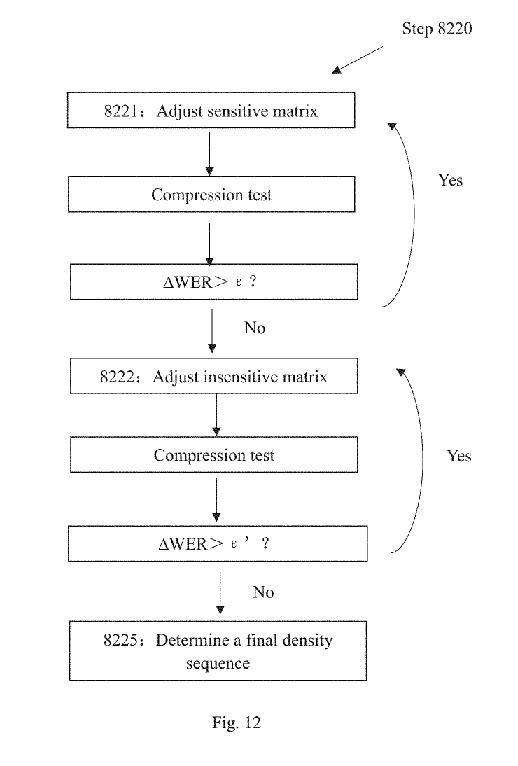

FIG. 12 shows specific steps in the “Compression-Density Adjustment” iteration.

As can be seen in FIG. 12, in step 8221, it adjusts the density of the matrices that are relatively sensitive. That is, for each sensitive matrix, it increases its initial density, for example, by 0.05. Then, it conducts a compression test for said matrix based on the adjusted density.

Then, it calculates the WER of the network after compression. If the WER is still unsatisfactory, it continues to increase the density of corresponding matrix, for example, by 0.1. Then, it conducts a further compression test for said matrix based on the re-adjusted density. It repeats the above steps until ΔWER of the networks before and after compression is below said threshold ε, for example, 4%.

Optionally or sequentially, in step 8222, the density of the matrices that are less sensitive can be adjusted slightly, so that ΔWER of the networks before and after compression may be below certain threshold ε′, for example, 3.5%. In this way, the accuracy of the network after compression can be further improved.

As can be seen in FIG. 12, the process for adjusting insensitive matrices is similar to that for sensitive matrices.

In one example, the initial WER of a network is 24.2%, and the initial density sequence of the network obtained in step 8100 is:

densityList=[0.2, 0.1, 0.1, 0.1, 0.3, 0.3, 0.1, 0.1, 0.3, 0.5, 0.1, 0.1, 0.1, 0.2, 0.1, 0.1, 0.1, 0.3, 0.4, 0.3, 0.1, 0.2, 0.3, 0.3, 0.1, 0.2, 0.5],

After pruning the network according to the initial density sequence, the WER of the compressed network is worsened to 32%, which means that the initial density sequence needs to be adjusted.

According to the result in step 8100, W_{cx}, W_{cr}, Wᵢᵣ, Wᵣₘ in the first layer, W_{cx}, W_{cr}, Wᵣₘ in the second layer, and W_{cx}, Wᵢₓ, Wₒₓ, W_{cr}, Wᵢᵣ, Wₒᵣ, Wᵣₘ in the third layer are relatively sensitive, while the other matrices are insensitive.

The steps for adjusting the initial density sequence is as follows:

First of all, it increases the initial densities of the above sensitive matrices by 0.05, respectively.

Then, it conducts compression tests based on the increased density. The resulting WER after compression is 27.7%, which meets the requirement of ΔWER<4%. Thus, the step for adjusting the densities of sensitive matrices is completed.

Optionally, the density of matrices that are less sensitive can be adjusted slightly, so that ΔWER of the network before and after compression will be below 3.5%.

Thus, the final density sequence obtained via “Compression-Density Adjustment” iteration is as follows:

densityList=[0.25, 0.1, 0.1, 0.1, 0.35, 0.35, 0.1, 0.1, 0.35, 0.55, 0, 0.1, 0.1, 0.25, 0.1, 0.1, 0.1, 0.35, 0.45, 0.35, 0.1, 0.25, 0.35, 0.35, 0.1, 0.25, 0.55]

The overall density of the neural network after compression is now around 0.24.

In Step 8230, it prunes based on the final density sequence.

In this embodiment, for each matrix, all elements are ranked from small to large according to their absolute values. Then, each matrix is compressed according to its final density, and only a corresponding ratio of elements with larger absolute values are remained, while other elements with smaller values are set to zero.

Step 8300, Fine Tuning

The training and fine-tuning process of a neural network is indeed a process for optimizing a loss function. A loss function refers to the difference between the ideal result and the actual result of a neural network model given a predetermined input. It is therefore desirable to minimize the value of the loss function.

Training a neural network aims at finding the optimal solution. Fine-tuning a neural network aims at finding the optimal solution based on a suboptimal solution, i.e., fine-tuning is to continue to train the neural network.

More specifically, for a trained LSTM neural network, we try to find the optimal solution. After being pruned in step 8200, the pruned network left with the remaining weights is the basis to find said optimal solution, which is called the fine-tuning process.

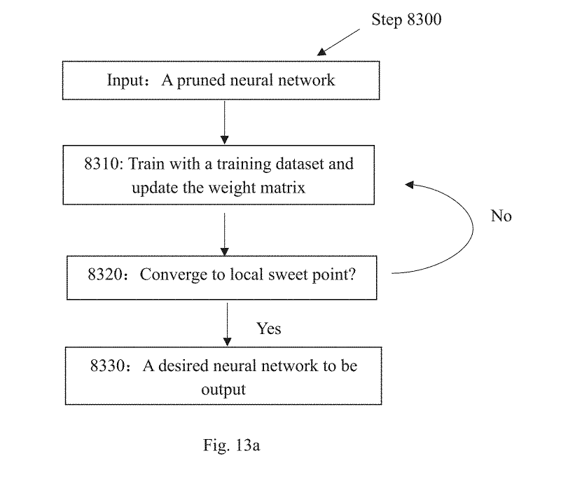

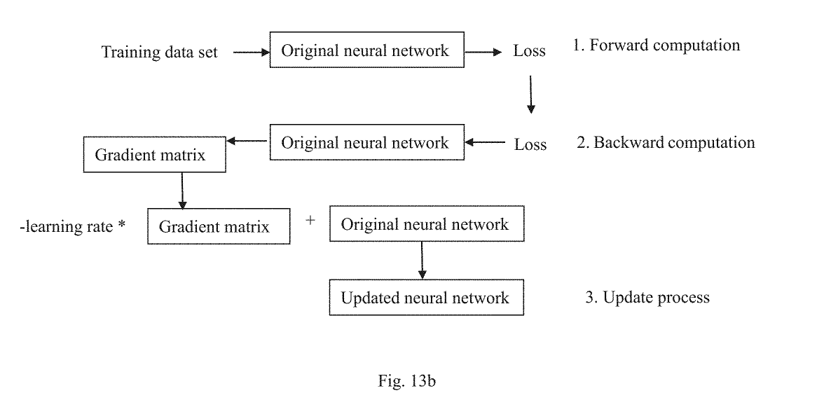

FIGS. 13a and 13b shows the specific steps in fine-tuning of a neural network.

As can be seen from FIG. 13a, the input of fine-tuning is the neural network after pruning in step 8200.

In step 8310, it trains the sparse neural network obtained in step 8200 with a training set, and updates the weight matrix.

Then, in step 8320, it determines whether the matrix has converged to a local sweet point. If not, it goes back to step 8310 and repeats the process; and if yes, it goes to step 8330 and outputs the final neural network.

In this embodiment, Gradient Descent Algorithm is used during fine-tuning to update the weight matrix.

More specifically, if real-value function F(x) is differentiable and has definition at point a, then F(x) descents the fastest along−∇F(a) at point a.

Thus, if:

b=a−γ∇F(a)

is true when γ>0 is a value that is small enough, then F(a)≥F(b), wherein a is a vector.

In light of this, we can start from x₀ which is the local minimal value of function F, and consider the following sequence x₀, x₁, x₂, . . . , so that:

xₙ₊₁=xₙ−γₙ∇F(xₙ),n≥0

Thus, we can obtain:

F(x₀)≥F(x₁)≥F(x₂)≥ . . .

Desirably, the sequence (xₙ) will converge to the desired extreme value. It should be noted that in each iteration, step γ can be changed.

Here, F(x) can be interpreted as loss function. In this way, Gradient Descent Algorithm can be used to help reducing prediction loss.

In one example and with reference to “DSD: Regularizing Deep Neural Networks with Dense-Sparse-Dense Training Flow in NIPS 2016”, the fine-tuning method of LSTM neural network is as follows:

[symbol]

--------------------Initial Dense Phase--------------------
while not converged do
| \ddot{W}^{(t)} = W^{(t-1)} − η^{(t)}∇ f(W^{(t-1)};x^{(t-1)});
| t = t + 1;
end

Here, W refers to the weight matrix, η refers to learning rate (i.e., the step of the Gradient Descent Algorithm), f refers to the loss function, ∇F refers to a gradient of the loss function, x refers to training data, and t+1 refers to weight update.

The above equations mean updating the weight matrix by subtracting the product of learning rate and gradient of the loss function from the weight matrix.

FIG. 13b is a schematic diagram showing the process of updating a neural network using the Gradient Descent Algorithm.

In Step 8300, it may adopt various methods to fine-tune the sparse neural network and update corresponding weight matrices.

In this embodiment, it uses a mask matrix to keep the distribution of non-zero elements in the matrix after compression. The mask matrix is generated during pruning and contains only elements “0” and “1”, wherein element “1” means that the element in corresponding position of the weight matrix is remained, while element “0” means that the element in corresponding position of the weight matrix is ignored (i.e., set to 0).

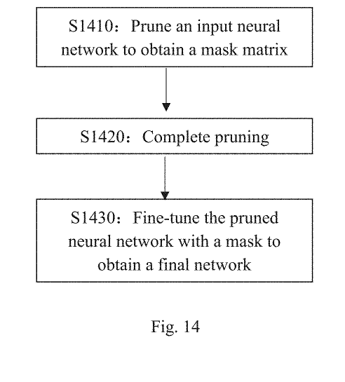

FIG. 14 shows the process of fine-tuning a neural network using a mask matrix.

As is shown in FIG. 14, in step 1410, it prunes the network to be compressed nnet⁰ and obtains a mask matrix M which records the distribution of non-zero elements in corresponding sparse matrix:

nnet⁰→M

In step 1420, it point-multiplies the network to be compressed with the mask matrix M obtained in step 1410, and completes the pruning process so as to obtain the network after pruning nnetᵢ:

nnetᵢ=M⊙nnet⁰

In step 1430, it retrains the network after pruning nnetᵢ using the mask matrix so as to obtain the final output network nnetₒ:

nnetₒ=Rₘₐₛₖ(nnetᵢ,M)

In general, the fine-tuning process with mask can be expressed as follows:

\tilde{W}^{(t)}=W^{(t-1)}−η^{(t)}∇f(W^{(t-1)},x^{(t-1)})·Mask

Mask=(W⁽⁰⁾≠0)

As can be seen from the above equations, the gradient of the loss function is multiplied by the mask matrix, assuring that the gradient matrix will have the same shape as the mask matrix.

Thus, the WER of the network decreases via fine-tuning, reducing accuracy loss due to compression. For example, the WER of a compressed LSTM network with a density of 0.24 can drop from 27.7% to 25.8% after fine-tuning.

Iteration (Repeating 8100, 8200 and 8300)

Referring again to FIG. 8, as mentioned above, the neural network will be compressed to a desired density via multi-iteration, that is, by repeating the above-mentioned steps 8100, 8200 and 8300.

For example, the desired final density of one exemplary neural network is 0.14.

After the first iteration, the network obtained after Step 8300 has a density of 0.24 and a WER of 25.8%.

Then, steps 8100, 8200 and 8300 are repeated.

After the second iteration, the network obtained after Step 8300 has a density of 0.18 and a WER of 24.7%.

After the third iteration, the network obtained after Step 8300 has a density of 0.14 and a WER of 24.6% which meets the requirements.

### Embodiment 2

As described above, it proposes a compression method for a trained dense neural network using a mask matrix in Embodiment 1.

In Embodiment 2, it proposes another novel compression method for neural networks, wherein in each compression cycle, it uses a dynamic compression strategy to compress the neural network.

Specifically, the dynamic compression strategy includes: the current number of pruning operation, the total number of pruning operation, and the target density of the current pruning operation. The proportion of weights that needs to be pruned by the current pruning operation is thus determined by these parameters.

Thus, during the compression process according to Embodiment 2, the proportion of weights that needs to be pruned is a function of time t. In other words, during the compression process, the density of the neural network may vary with each pruning operation, instead of being constant during the whole compression cycle.

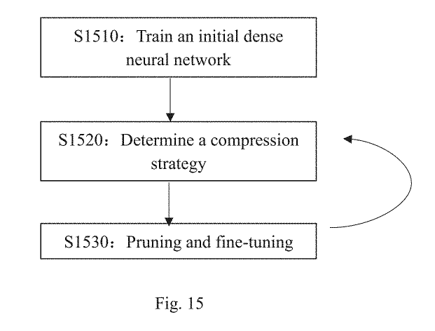

FIG. 15 shows a compression cycle of the compression method according to Embodiment 2, which includes the following three steps: training an initial dense neural network, determining a compression strategy, and pruning & fine-tuning. Now, each step will be described in detail below.

### Step 1510: Training an Initial Dense Neural Network

In Step 1510, it trains an initial dense neural network to obtain a trained dense neural network.

Here, the trained dense neural network may be a trained dense neural network with a desired accuracy as described in Embodiment 1.

However, unlike Embodiment 1, in Embodiment 2, Step 8100 of Embodiment 1 may be omitted. Thus, the trained dense neural network may also be an intermediate neural network nnet_{half}, which has converged but has not reached a desired accuracy.

### Step 1520: Determining a Compression Strategy

In Embodiment 2, a compression strategy at least includes: the target final density D_{final} and the compression function f_{D}(t, D_{final}) of the current compression cycle, wherein the compression function f_{D}(t, D_{final}) determines the total number of pruning operation of the current compression cycle, and the target density Dₜ of each pruning operation.

Specifically, assuming that the weight matrix of the neural network before the t^{th} pruning operation is Wₜ, and the target density of the t^{th} pruning operation is Dₜ, then the weight matrix after the pruning operation is:

Wₜ₊₁=f_{W}(Wₜ,Dₜ)

wherein f_{W}(Wₜ, Dₜ) means pruning the weight matrix of the neural network Wₜ according to the target density of the t^{th} pruning operation Dₜ. In this way, during the compression process of the neural network, the density variation of the neural network can be expressed as a function of time t, or a function of the number of pruning operations.

Since during the whole compression process, weight matrix Wₜ is obtained directly from training/fine-tuning an original neural network, the target density of each pruning operation is determined only by the target final density and the current number of pruning operation (or time t), i.e.:

Dₜ=f_{D}(t,D_{final})

wherein f_{D} (t, D_{final}) is a function used for calculating the target density Dₜ at time t (also referred to as “compression function”), and D_{final} is the target final density of the neural network of the current compression cycle.

Therefore, in order to achieve better compression effect, in actual practice, the compression strategy may be designed from two aspects: the compression function f_{D}(t, D_{final}), and the target final density D_{final}, so as to obtain a sparse neural network with a desired accuracy.

Design of the Compression Function f_{D}(t, D_{final})

Different designs of the compression function may bring different compression effects. Now, two exemplary designs of the compression function will be described in detail below.

### Example 2.1 Compression with Constant Density

In this example, during one compression cycle, the target density of each pruning operation remains constant as the target final density. Accordingly, the compression function is as follows:

f_{D}(t)=D_{final}

In other words, during one compression cycle, the density of the neural network remains constant, while values and distributions of the weights may vary in each pruning operation.

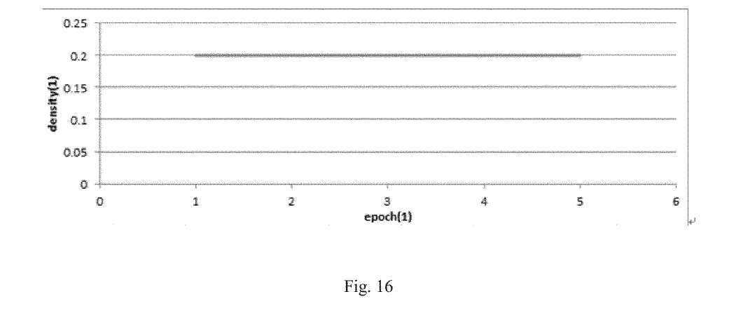

FIG. 16 shows the density variation curve of the neural network in Example 2.1.

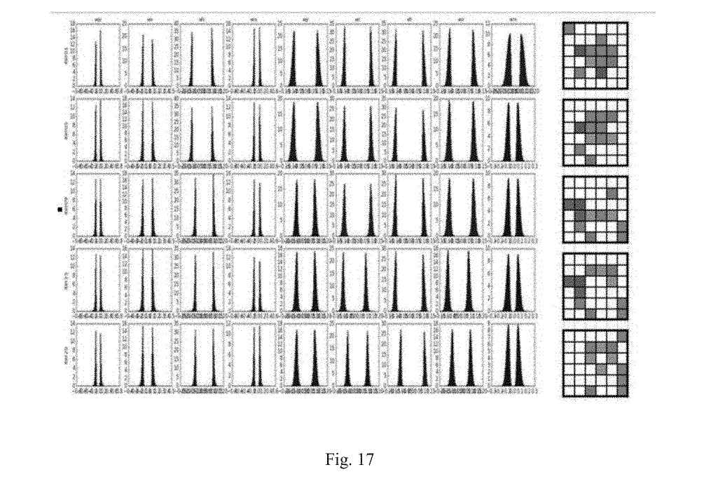

FIG. 17 shows the corresponding variation of weight distribution of the neural network in Example 2.1.

The left portion of FIG. 17 shows the variation of weight distribution of each matrix during each pruning operation, wherein the horizontal axis represents the 9 matrices in each LTSM layer, and the vertical axis represents the number of pruning operation. As can be seen in FIG. 17, in this example, five pruning operations have been conducted.

The right portion of FIG. 17 is a corresponding schematic view showing a simplified weight distribution after each pruning operation, wherein colored blocks of different shades represent different weight values (i.e., those weights in corresponding position have been remained), and blocks with no color (i.e., blank blocks) represent weight value equals to 0 (i.e., those weights in corresponding position have been set to zero).

As can be seen from FIG. 17, during the five pruning operations, the total number of colored blocks remains unchanged, i.e., the density of the neural network remains unchanged. However, shade and distribution of the colored blocks keep changing, i.e., values and distributions of the weights keep changing.

Actually, the fine-tuning process described in Embodiment 1 may be regarded as a particular case of Example 2.1, wherein the corresponding compression function is as follows:

f_{D}(t)=D_{final}

Moreover, the weight distribution of the neural network in Embodiment 1 is further restricted by a mask matrix.

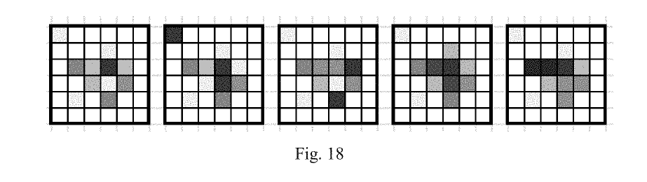

FIG. 18 shows corresponding variation of weight distribution of the neural network being compressed using a mask matrix.

As can be seen from FIG. 18, although shades of the colored blocks keeps changing, colored blocks remain. That is, a non-zero weight of a corresponding position will not be set to zero.

Accordingly, in Embodiment 1, weight values of the neural network may vary, while distributions of weight remain unchanged, i.e., no freedom in term of shape change.

### Example 2.2 Compression with a Linearly Decreased Density

In this example, during one compression cycle, the target density of each pruning operation decreases gradually. Accordingly, the compression function is as follows:

Dₜ=1−(t_{current}−tₛₜₐᵣₜ)/(t_{end}−tₛₜₐᵣₜ)×(1−D_{final})

In other words, the density of the neural network decreases linearly to the target final density D_{final} within a predetermined number of pruning operations.

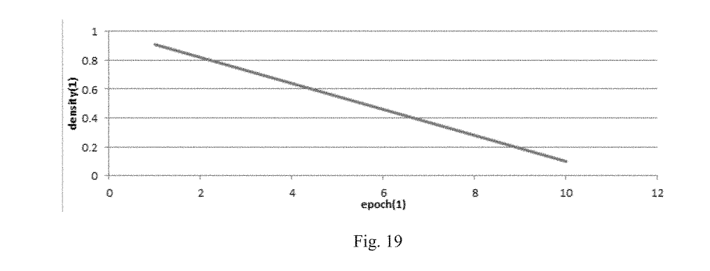

FIG. 19 shows the density variation curve of the neural network in Example 2.2.

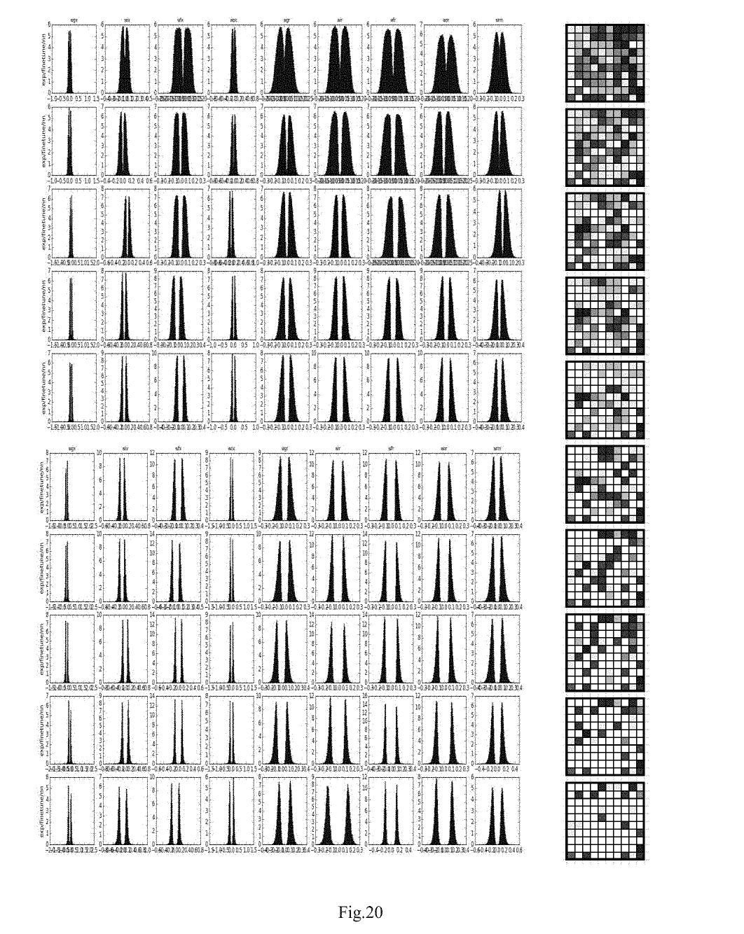

FIG. 20 shows variation of weight distribution of the neural network in Example 2.2.

The left portion of FIG. 20 shows variation of weight distribution of each matrix during each pruning operation. As can be seen in FIG. 20, in this example, 10 pruning operations have been conducted.

The right portion of FIG. 20 is a corresponding schematic view showing a simplified weight distribution after each pruning operation. As can be seen from FIG. 20, during the 10 pruning operations, the total number of colored blocks decreases, i.e., the density of the neural network decreases. Meanwhile, shade and distribution of the colored blocks keep changing, i.e., the value and distribution of the weights keep changing.

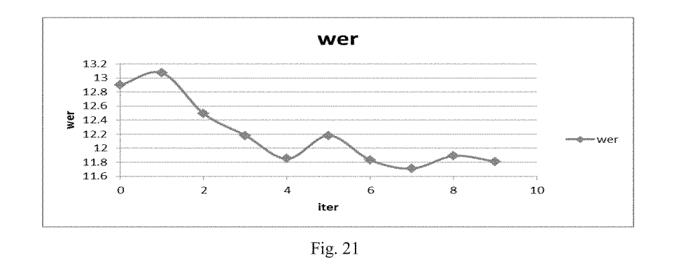

FIG. 21 shows variation of WER (Word Error Rate) of the neural network in Example 2.2.

As can be seen in FIG. 21, after 10 pruning operations, the WER of the neural network decreases gradually. In other words, the accuracy of the neural network keeps increasing.

It should be understood that, regarding the design of compression function f_{D}(t, D_{final}), one may select the above mentioned functions, or other high-order functions. The specific type of compression function is not limited by the embodiments disclosed here.

Moreover, the compression function f_{D}(t, D_{final}) may also be determined through a deep learning process.

For example, a time-dependent neural network (for example, a Recurrent Neural Network RNN) may be used to learn relevant neural network parameters. The process may be expressed as follows:

Dₜ₊₁=WₜDₜ+bₜ

Wₜ₊₁=W_{uw}Wₜ

bₜ₊₁=W_{ub}bₜ

Therefore, once the initial matrix Wₜ and the transition matrices W_{uw}, W_{ub} are obtained through training, the density at time t may be determined based on the density at time t−1. In this way, the compression function itself may be obtained through training.

### Design of the Target Final Density D_{final}

Regarding the design of target final density D_{final}, a target final density may be set in advance.

In addition, the target final density D_{final} for one compression cycle may be determined according to the method described in Step 8100 of Embodiment 1.

Specifically, it conducts a sensitivity test on the dense neural network obtained in Step 1510, and then obtains an acceptable density as the target final density of the current compression cycle.

It should be understood that the design of target final density is not limited by the present application.

### Step 1530: Pruning and Fine-Tuning

In Step 1530, it prunes and fine-tunes the dense neural network obtained in Step 1510 based on the compression strategy determined in Step 1520, until the neural network reaches the target final density D_{final} of the current compression cycle.

As described above, on the basis of the compression strategy, the total number of pruning operation and the target density Dₜ of the each pruning operation may be determined. For each pruning operation, since compression of the neural network will cause an accuracy loss, fine-tuning is needed after each pruning operation to restore the accuracy of the neural network.

Thus, Step 1530 further includes: Step 1531 of pruning and Step 1532 of fine-tuning.

In the present embodiment, the pruning operation conducted in Step 1531 may be similar to that described in Step 8230 of Embodiment 1.

Specifically, in Step 1531, all elements are ranked from small to large according to their absolute values. Then, each matrix is compressed according to the target density Dₜ of the current pruning operation, and only a corresponding ratio of elements with larger absolute values are remained, while other elements with smaller values are set to zero.

In the present embodiment, the fine-tuning operation conducted in Step 1532 may be similar to that described in Step 8300 of Embodiment 1. That is, a mask matrix may be used to fine-tune the pruned neural network.

Specifically, it obtains a mask matrix which records the distribution of non-zero elements in the matrix after the current pruning operation. Then, it fine-tunes the pruned neural network using the mask matrix, so as to restore the accuracy of the neural network.

It should be understood that Step 1531 and Step 1532 may be conducted in other ways. The present application does not limit the specific method used in Step 1531 and Step 1532.

Finally, Step 1531 and Step 1532 are conducted iteratively according to the total number of pruning operations determined by the compression strategy, until the neural network reaches the target final density D_{final} of the current compression cycle.

### Compression Iteration

Still with reference to FIG. 15, the compression method according to Embodiment 2 may include a plurality of compression cycles.

Specifically, first, the target final density of each compression cycle may be determined respectively as D_{final1}, D_{final2}, . . . , D_{finaln}, and the corresponding compression function may be determined as f_{D}(t, D_{final1}), f_{D}(t, D_{final2}), . . . , f_{D}(t, D_{finaln}). Then, Step 1520 and Step 1530 are conducted iteratively, so as to compress the neural network to a desired density to be output.

For example, for a dense neural network to be compressed according to Embodiment 2, assuming that a desired output density is Dₒᵤₜₚᵤₜ=0.2. In addition, three compression cycles will be conducted, and the target final density D_{final} of each compression cycle is respectively 0.6, 0.4, 0.2.

Firstly, a first compression cycle is conducted, wherein the target final density thereof is D_{final1}=0.6.

Specifically, with reference to Step 1520 described above, it determines the compression strategy of the current compression cycle. For example, the compression strategy may be set according to Example 2.2, wherein the target density of each pruning operation decreases linearly and the total number of pruning operation is set to 4. Accordingly, the target density of each pruning operation is respectively D₁=0.9, D₂=0.8, D₃=0.7, and D₄=0.6. Then, it conducts four pruning and fine-tuning operations based on the target density of each pruning operation, so as to compress the dense neural network to the target final density of the current compression cycle.

Then, a second compression cycle and a third compression cycle are conducted similarly, until the dense neural network is compressed to the desired output density of Dₒᵤₜₚᵤₜ, which is 0.2. For each compression cycle, a different compression strategy may be determined accordingly.

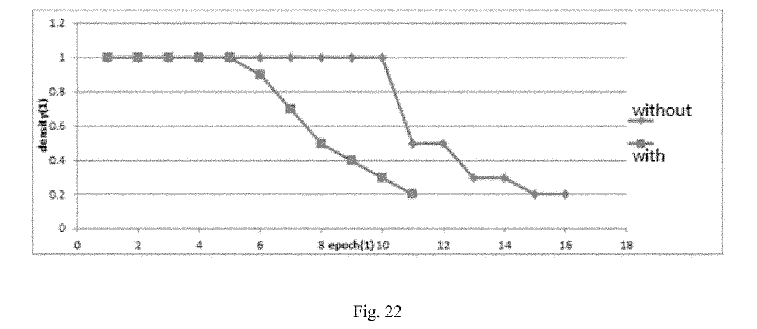

FIG. 22 shows the density variation curve of a neural network trained and compressed according to the method of Embodiment 2, as well as the density variation curve of a neural network trained and compressed without applying the method of Embodiment 2.

As can be seen in FIG. 22, in order to achieve the identical desired output density, the compression method according to Embodiment 2 allows a user to design the density variation path. Therefore, compression may be started even before the initial dense network has converged to a desired accuracy, and the compression density may be decreased gradually, so as to achieve a desired output density in a shorter period.

### Beneficial Technical Effects

The compression method according to Embodiment 2 allows to compress an initial neural network during the training process, instead of having to wait for a trained neural network to initiate the compression process.

Therefore, the compression method of Embodiment 2 may effectively shorten the training and compression process while ensuring a desired accuracy of the final network.

It should be understood that although the above-mentioned embodiments use LSTM neural networks as examples of the present disclosure, the present disclosure is not limited to LSTM neural networks, but can be applied to various other neural networks as well.

Moreover, those skilled in the art may understand and implement other variations to the disclosed embodiments from a study of the drawings, the present application, and the appended claims.

In the claims, the word “comprising” does not exclude other elements or steps, and the indefinite article “a” or “an” does not exclude a plurality.

In applications according to present application, one element may perform functions of several technical feature recited in claims.

Any reference signs in the claims should not be construed as limiting the scope. The scope and spirit of the present application is defined by the appended claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. A method for configuring a computer system comprising a network of processors, the network comprising a set of first processors and a set of second processors, wherein outputs of the first processors are coupled to outputs of the second processors; the method comprising:
predetermining a first fraction of reduction of coupling of the outputs of the first processors to the outputs of the second processors;
adjusting the network by reducing the coupling, by the first fraction of reduction;
predetermining a second fraction of reduction of the coupling of the outputs of the first processors to the outputs of the second processors;
adjusting the network by further reducing the coupling, by the second fraction of reduction;
generating a display based on the outputs of the first processors after the network is adjusted.

18. The method of claim 17, wherein predetermining the first fraction of reduction is based on a first target amount of the coupling.

19. The method of claim 18, wherein the first target amount is a function of a final target amount of the coupling.

20. The method of claim 17, wherein predetermining the second fraction of reduction is based on a second target amount of the coupling.

21. The method of claim 20, wherein predetermining the first fraction of reduction is based on a first target amount of the coupling; and wherein the second target amount equals the first target amount.

22. The method of claim 20, wherein predetermining the first fraction of reduction is based on a first target amount of the coupling; and wherein the second target amount is less than the first target amount.

23. The method of claim 20, wherein predetermining the first fraction of reduction is based on a first target amount of the coupling; and wherein predetermining the second fraction of reduction is based on the first target amount.

24. The method of claim 19, further comprising obtaining the final target amount of the coupling based on a relationship between the coupling and a word error ratio (WER) of the network.

25. The method of claim 17, wherein reducing the coupling comprises ranking strengths of coupling between pairs of the outputs of the first processors and the outputs of the second processors.

26. The method of claim 17, further comprising: after reducing the coupling, adjusting the network by further adjusting the coupling.

27. The method of claim 26, wherein further adjusting the coupling is based on a set of training data.

28. The method of claim 17, further comprising:
obtaining a first constraint of a distribution of non-zero coupling between pairs of the outputs of the first processors and the outputs of the second processors;
wherein reducing the coupling by the first fraction of reduction is subject to the first constraint.

29. The method of claim 17, further comprising:
obtaining a second constraint of a distribution of non-zero coupling between pairs of the outputs of the first processors and the outputs of the second processors;
wherein further reducing the coupling by the second fraction of reduction is subject to the second constraint.

30. The method of claim 29, further comprising:
obtaining a first constraint of a distribution of non-zero coupling between pairs of the outputs of the first processors and the outputs of the second processors;
wherein reducing the coupling by the first fraction of reduction is subject to the first constraint; and
wherein the first constraint and the second constraint are different.

31. A computer program product comprising a non-transitory computer readable medium having instructions recorded thereon, the instructions when executed by a computer implementing a method for configuring a computer system comprising a network of processors, the network comprising a set of first processors and a set of second processors, wherein outputs of the first processors are coupled to outputs of the second processors;
the method comprising:
predetermining a first fraction of reduction of coupling of the outputs of the first processors to the outputs of the second processors;
adjusting the network by reducing the coupling, by the first fraction of reduction;
predetermining a second fraction of reduction of the coupling of the outputs of the first processors to the outputs of the second processors;
adjusting the network by further reducing the coupling, by the second fraction of reduction;
generating a display based on the outputs of the first processors after the network is adjusted.
